(19) United States
(12) Patent Application Publication
(10) Pub. No.: US 2008/0250127 A1
(43) Pub. Date: Oct. 9, 2008

(54) NETWORK MANAGEMENT PROGRAM, NETWORK MANAGEMENT DEVICE, AND NETWORK MANAGEMENT METHOD

(75) Inventor: Kouji Sugisawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/139,837

(22) Filed: Jun. 16, 2008

Related U.S. Application Data
(63) Continuation of application No. PCT/JP2006/301247, filed on Jan. 26, 2006.

(51) Int. Cl. G06F 15/177

(52) U.S. Cl. 709/221

(57) ABSTRACT

When a new service is implemented by adding a server, a network management device detects a network device requiring setting modification. Next, the network management device presents to an administrator a plurality of samples corresponding to the detected network device requiring setting modification and selects a sample selected by the administrator as setting modification content. Specifically, the network management device retrieves from a sample database a plurality of samples corresponding to the network device requiring setting modification, presents the retrieved samples to the administrator so that the administrator can select one, selects the sample selected by the administrator as the setting modification content, and sets the selected setting modification content to the network device.

This application is a Continuation of International PCT Application No. PCT/JP2006/301247 filed Jan. 26, 2006.

### BACKGROUND OF THE INVENTION

1. Field of the Invention

The present invention relates to a computer program product having a network management program implemented by a computer to manage a structure definition of network devices that constitute a network.

2. Description of the Related Art

In today's information technology (IT) systems driven by change and growth of business, it is necessary to add needed server resources to the network when it is required. Adding server resources to a network entails setting new structure definitions (such as load distribution setting and filtering management setting) for network devices (such as switching hubs, firewalls, and server load balancers) that form the network. Since a typical IT system consists of many network devices, the settings need to be modified for a plurality of network devices, and care needs to be taken to ensure that settings of all the network devices are consistent. Also, modifying the settings all the network devices in the network that require setting modification can be prone to cause human errors and a time-consuming process. There are technologies disclosing a method for modifying the settings for the necessary network devices when a server resource is added to the network.

For example, Japanese Patent Application Laid-open No. 2004-289334 discloses a technology for modifying the settings of structure definition of the required network devices based on the structure definition already set by a system administrator. Specifically, this technology presupposes that the server resource is being added to provide an existing service. For example, if, with a view to expanding the existing service, a new Web server is to be added to a system that is using a load balancer to carry out load distribution to several Web servers, information such as IP address of the newly added Web server needs to be entered in the load distribution policy already set in the load balancer.

However, the technology described above fails to provide an easy way to add new settings to the structure definition of the network devices if a server resource is added with a view to providing a new service. For example, if a server resource is added to the system for providing a new service, the system administrator has to modify the structure definition manually, making it a burdensome task prone to human errors.

### SUMMARY

It is an object of the present invention to at least partially solve the problems in the conventional technology.

According to an aspect of the present invention, a computer program product having a computer readable medium including programmed instructions for managing structure definition of network devices that form a network, wherein the instructions, when executed by a computer, cause the computer to perform registering, in a sample storage unit, a sample for setting configuration definitions of the network devices; searching for a network device requiring modification of structure definition when a server resource is added to provide a new service; reading, from the sample storage unit, the sample corresponding to the network device detected by the searching to present the sample; and modifying the configuration definition of the network device based on information received from the sample presented.

According to another aspect of the present invention, a network management device for managing structure definition of network devices that form a network, includes a sample registering unit that registers in a sample storage unit a sample for setting configuration definitions of the network devices; a network-device searching unit that searches for a network device requiring modification of structure definition when a server resource is added to provide a new service; a sample presenting unit that reads, from the sample storage unit, the sample corresponding to the network device detected by the network-device searching unit to present the sample; and a structure-definition modifying unit that modifies the configuration definition of the network device based on information received from the sample presented by the sample presenting unit.

According to still another aspect of the present invention, a network management method for managing structure definition of network devices that form a network, includes registering, in a sample storage unit, a sample for setting configuration definitions of the network devices; searching for a network device requiring modification of structure definition when a server resource is added to provide a new service; reading, from the sample storage unit, the sample corresponding to the network device detected by the searching to present the sample; and modifying the configuration definition of the network device based on information received from the sample presented.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining an overview and salient feature of a network management device 10 according to a first embodiment of the present invention;

FIG. 2 is a block diagram of the network management device 10 according to the first embodiment.

FIG. 3 is a general flowchart of the processes performed by the network management device 10 according to the first embodiment.

FIGS. 4 to 9 are detailed flowcharts of the processes performed by the network management device 10 according to the first embodiment.

FIG. 10 is an explanatory drawing of contents of a network device database 14a;

FIG. 11 is an explanatory drawing of contents of the network device database 14a;

FIG. 12 is an explanatory drawing of contents of a service database 14b;

FIG. 13 is an explanatory drawing of a sample; and

FIG. 14 is a block diagram of a computer that implements a network management program.

### DETAILED DESCRIPTION OF THE PREFERRED EMBODIMENTS

Exemplary embodiments of the network management device according to the present invention are described below with reference to the accompanying drawings.

Described first is an overview and salient feature of the network management device according to a first embodiment of the present invention, followed by descriptions of the configuration and process flows of the network management device, and finally, the effects due to the first embodiment.

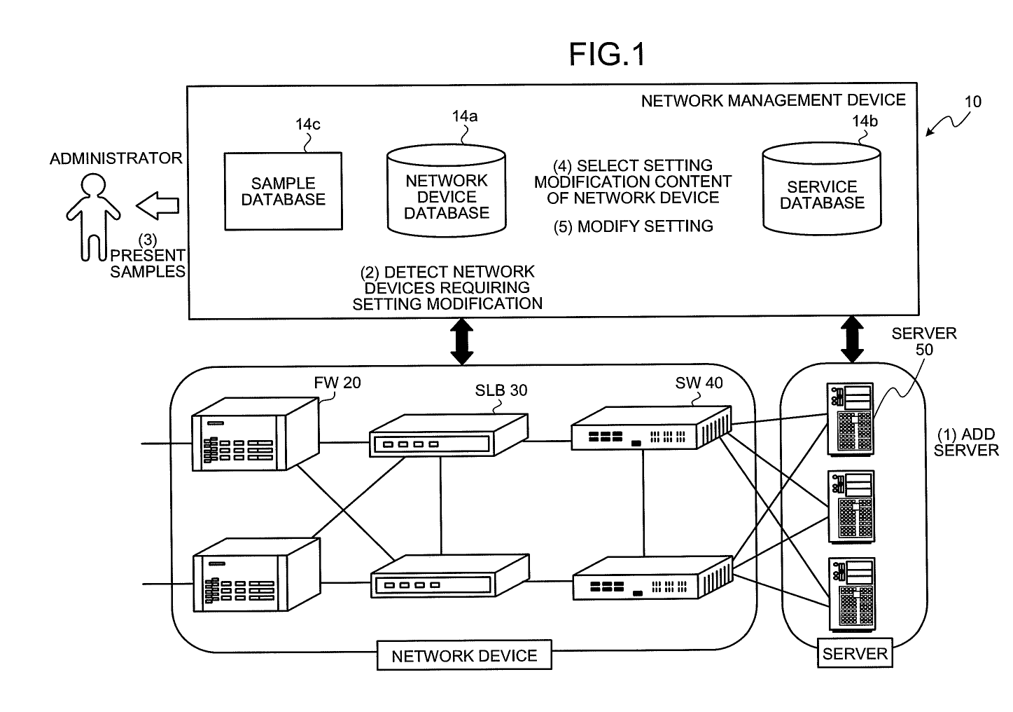

FIG. 1 is a schematic diagram for explaining an overview and the salient feature of a network management device 10 according to the first embodiment.

The network management device 10 causes a computer to implement a method of managing a structure definition of network devices forming a network. The salient feature of the network management device 10 is that settings of the network devices are modified based on a sample, thus reducing the workload involved in making setting modification of the network devices and the proneness to human errors in the process.

The salient feature is described in detail. As shown in FIG. 1, the network management device 10 according to the first embodiment is connected to network devices which constitute a network, the network devices include an FW (firewall) 20, an SLB (server load balancer) 30, and a SW (switching hub) 40) and to a server 50 including a web server, application server, or a database server. The network management device 10 includes a network device database 14a, a service database 14b, and a sample database 14c. The network device database 14a stores information pertaining to the network devices that constitute the system. The service database 14b stores information pertaining to the operational services and the server. The sample database 14c stores a sample of the structure definition of the network devices for each type of network device.

When the server 50 is added to the network to implement a new service (see (1) of FIG. 1), the network management device 10 detects the network devices that are targets of setting modification (see (2) of FIG. 1). Specifically, the network management device 10 detects the network devices starting from the SW 40 to which the newly added server 50 is connected, and traces the physical connections in both directions (forward and backward) of communication until a switch connected to the Internet, another server, or a non-control network device is detected.

The network management device 10 then presents to the administrator a plurality of samples corresponding to the network device detected as a target of setting modification (see (3) of FIG. 1), and determines the sample selected by the administrator as the settings modification content of the network device (see (4) of FIG. 1). Specifically, the network management device 10 retrieves from the sample database 14c the samples corresponding to the network device that is a target of setting modification, and presents the samples to the administrator for selection, and determines the sample selected by the administrator as the settings modification content of the network device. The network management device 10 then sets the determined setting modification content in the network device (see (5) of FIG. 1).

Thus, the network management device 10 is capable of making setting modification of the network device based on samples as described above, thus reducing the workload involved in making setting modification of the network devices and the proneness to human errors in the process.

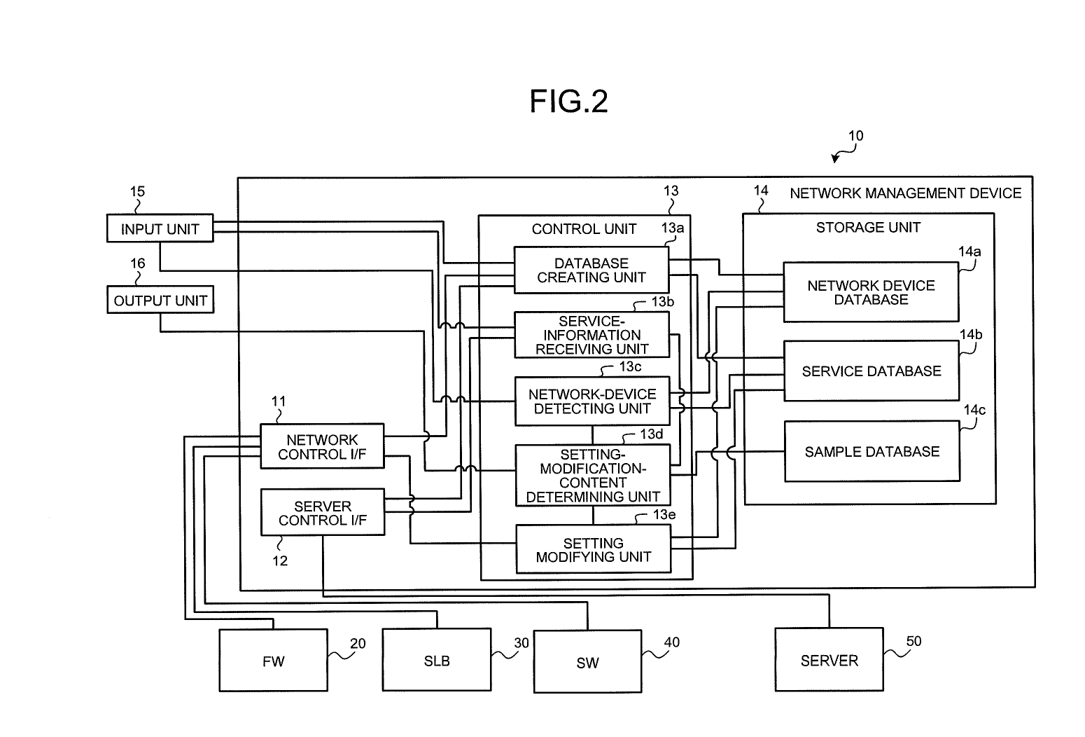

FIG. 2 is a block diagram of the network management device 10 according to the first embodiment. The network management device 10 includes a network control interface (I/F) 11, a server control I/F 12, a control unit 13, and a storage unit 14, and is connected to the FW 20, the SLB 30, the SW 40, and the server 50 via a bus and the like.

The network control I/F 11 controls the communication of the network management device 10 with each of the FW 20, the SLB 30, and the SW 40 by controlling the exchange of data among them. Specifically, the network control I/F 11 controls the exchange of data concerning the network device information (such as VLAN-ID) among the network management device 10 and the FW 20, the SLB 30, and the SW 40.

The server control I/F 12 controls the communication of the network management device 10 with the server 50 by controlling the exchange of data between them. Specifically, the server control I/F 12 controls the exchange of server information between the network management device 10 and the server 50.

The storage unit 14 stores therein various types of data and programs required by the control unit 13 to perform the various processes. In close relevance to the present invention, the storage unit 14 stores therein the network device database 14a, the service database 14b, and the sample database 14c. The sample database 14c may be referred to as a sample storage unit.

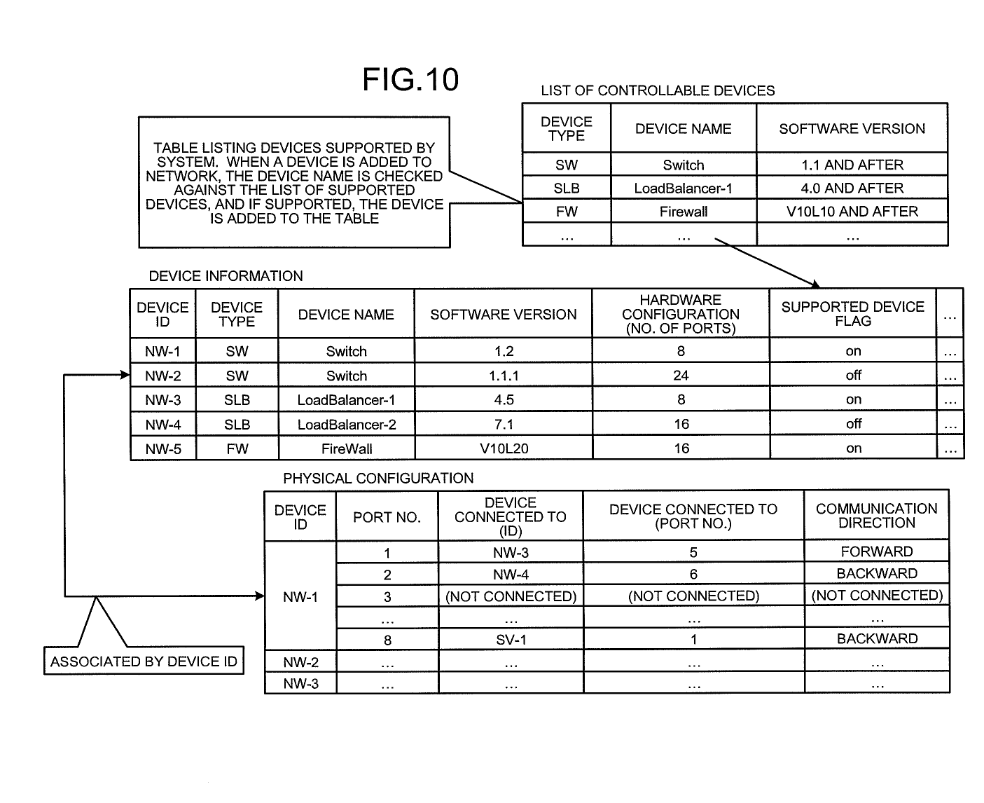

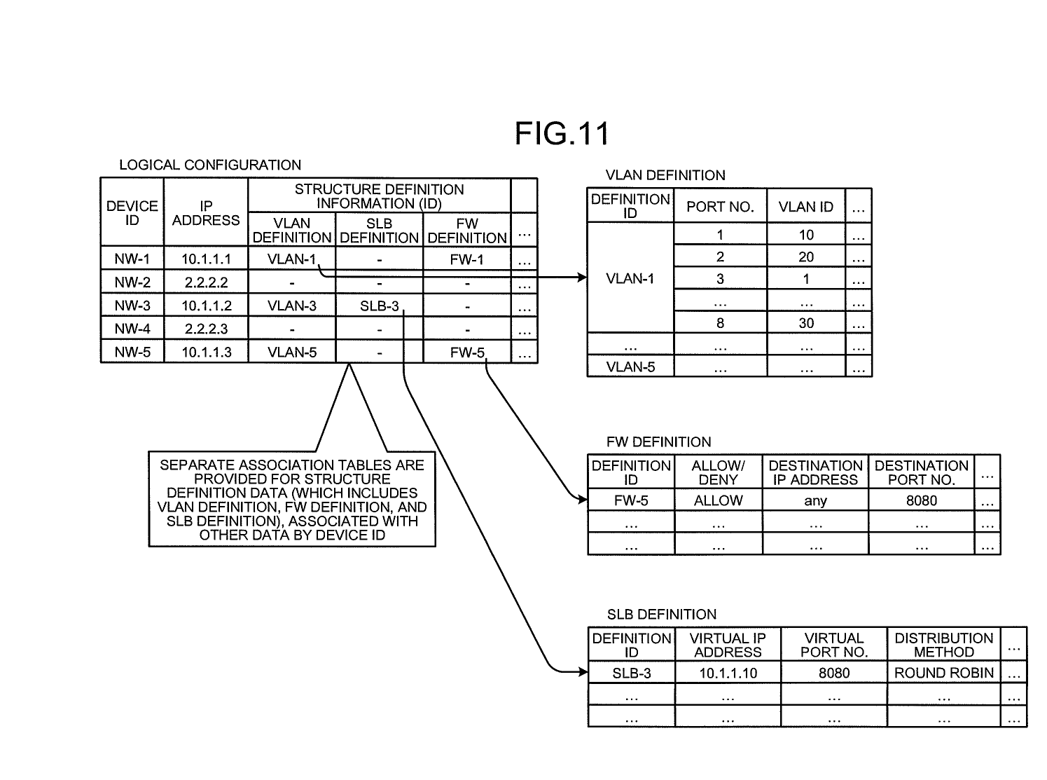

The network device database 14a stores data pertaining to the network devices that constitute the system. Specifically, as shown in FIGS. 10 and 11, the network device database 14a stores tables such as “controllable device list”, “device information”, “physical configuration”, and “logical configuration”. The “controllable device list” contains a list of network devices controllable by the network management device 10. The “device information” table stores information concerning the network device. The “physical configuration” table stores data concerning the physical connection location of each network device. The “logical configuration” table stores data concerning logical configuration of each network device.

The “logical configuration” table of the network device database 14a stores, for each network device configuration definition, data in the form of VLAN definition, FW definition, and SLB definition. The values of VLAN definition, FW definition, and SLB definition are associated respectively, with a LAN definition table, an SW definition table, and an SLB definition table.

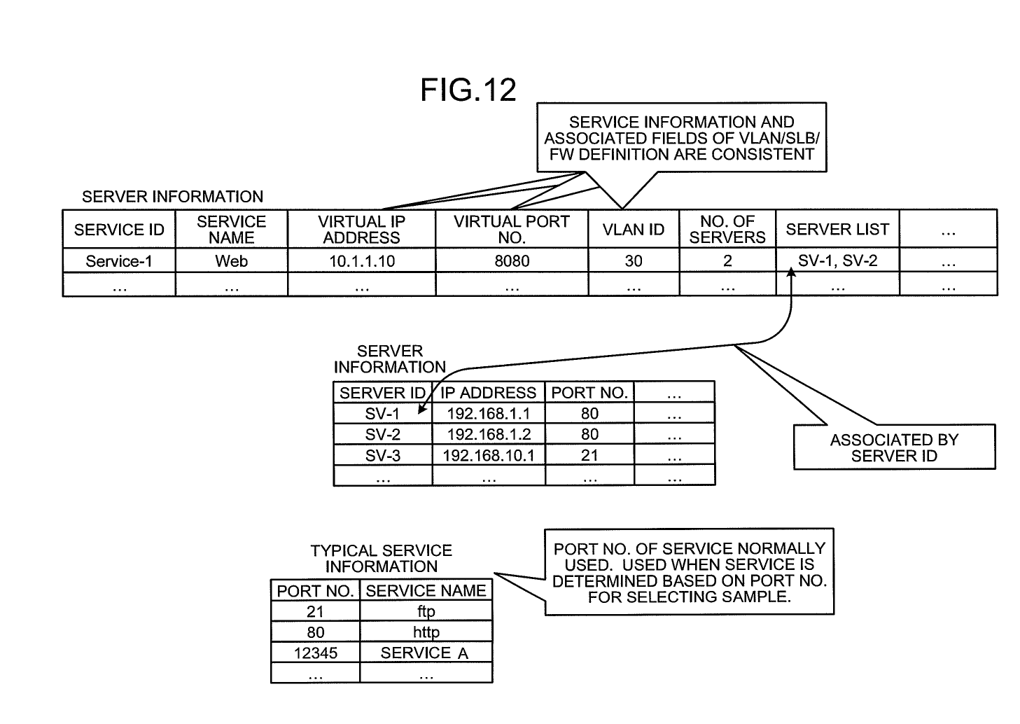

The service database 14b stores information pertaining to the operational services and the servers. Specifically, as shown in FIG. 12, the service database 14b stores tables “service information“”, “server information”, and “typical service information”. The table “service information” stores data concerning the services. The table “server information” stores data concerning the servers. The table “typical service information” stores data concerning the typically used services.

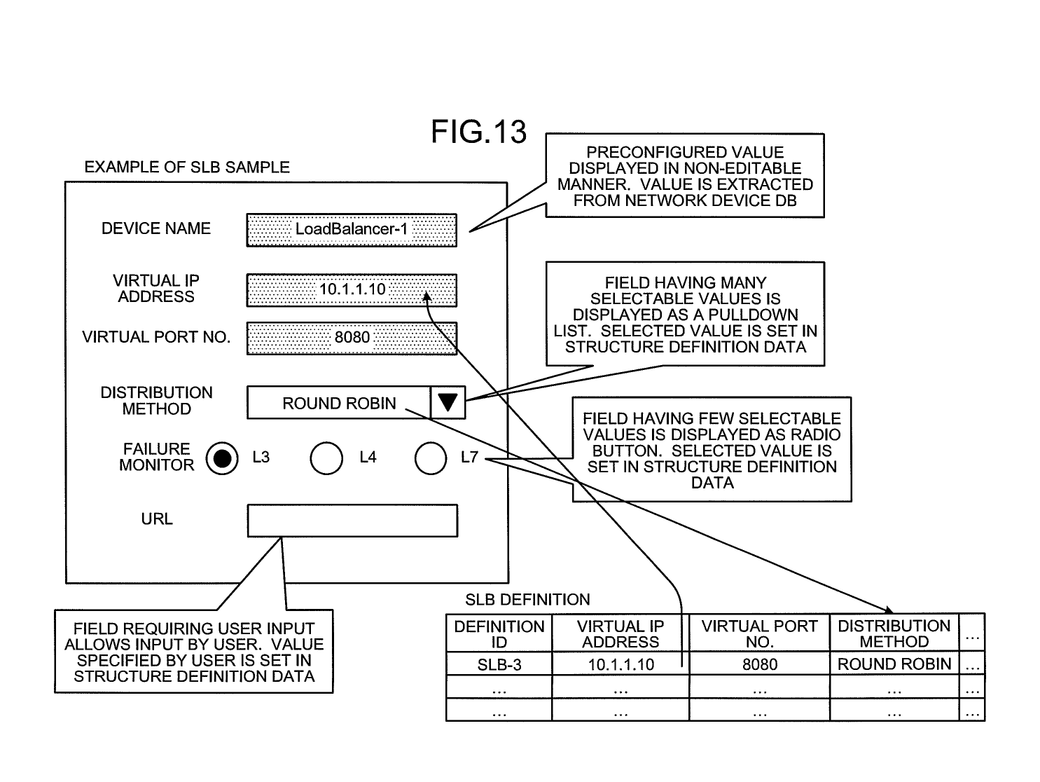

The sample database 14c stores samples of the structure definition of the network devices. Specifically, as shown in FIG. 13, the sample database 14c stores samples of the structure definition of the network devices for each type of network device. Further, the sample database 14c stores the samples of the structure definition of the network devices based on the service information, server information, and service information newly added by a service-information receiving unit 13b.

The control unit 13 includes an internal memory for storing therein programs stipulating various process procedures and data required, the control unit 13 is a processing unit that performs various processes using the programs and data. In close relevance to the present invention, the control unit 13 includes a database creating unit 13a, the service-information receiving unit 13b, a network-device detecting unit 13c, a setting-modification-content determining unit 13d, and a setting modifying unit 13e. The service-information receiving unit 13b may be referred to as a sample registering unit, the network-device detecting unit 13c may be referred to as a network-device searching unit, the setting-modification-content determining unit 13d may be referred to as a sample presenting unit, and the setting modifying unit 13e may be referred to as a structure-definition modifying unit.

The database creating unit 13a is a processing unit that stores information concerning the network devices and the server 50, respectively in the network device database 14a and the service database 14b. Specifically, the database creating unit 13a stores the device information, the physical configuration, and the logical configuration of the network device input via an input unit 15 in the network device database 14a to build the network device database 14a. The database creating unit 13a then verifies whether the data stored in the network device database 14a is correct by executing a simple network management protocol (SNMP) command. In addition, the database creating unit 13a also stores the service information and the server information input via the input unit 15 in the service database 14b to build the service database 14b.

The database creating unit 13a stores or allows manual entry of those network devices that are not supported by the network management device 10 but whose type can be determined by SNMP. As the validity of the physical connectional relationship with a non-control device cannot be adequately confirmed, the database creating unit 13a stores the non-control device merely as reference information.

The service-information receiving unit 13b receives information concerning the service and the server to be added. Specifically, the service-information receiving unit 13b receives the service information and the server information input via the input unit 15, and verifies if the information is correct (that is, verifies whether an existing server is not being added). If the server information or the service information is not correct (that is, if a new service is added), the service-information receiving unit 13b requests input of network information concerning the network devices, and receives the information concerning the network via the input unit 15. The service-information receiving unit 13b lets the sample database 14c store the service information, the server information, and the network information in the sample database 14c.

The network-device detecting unit 13c detects the network devices that are targets of setting modification. Specifically, after recognizing the SW 40 connected to the server 50, the network-device detecting unit 13c, using the SW 40, detects the network device to which the server 50 is added from the network device database 14a. The network-device detecting unit 13c starts from the SW 40 and sequentially searches the devices in both directions (forward and backward) of communication. If no network device is detected, the network-device detecting unit 13c ends the search.

If a network device is detected, the network-device detecting unit 13c obtains the device information concerning the network device from the network device database 14a, and determines whether the network device is controllable. If the network device is controllable, the network-device detecting unit 13c detects the next network device in the communication direction based on the physical connectional relationship, and traces the devices in the communication direction until a switch connected to the Internet or to another server group is detected. If the SW 40 connected to the Internet or another server group is detected, the network-device detecting unit 13c ends the process of detecting the network devices requiring setting modification.

If the detected network device is uncontrollable, the network-device detecting unit 13c retrieves whether the type of device that is uncontrollable is registered in the network device database 14a. If the type of device that is uncontrollable is not registered in the network device database 14a, the network-device detecting unit 13c outputs to an output unit 16 information indicating that the settings cannot be modified. If the type of device that is uncontrollable is registered in the network device database 14a, the network-device detecting unit 13c determines if setting modification of the network device will affect the subsequent processes. If the subsequent processes will be affected by setting modification, the network-device detecting unit 13c outputs to the output unit 16 information indicating that the settings cannot be modified. If the subsequent process will not be affected by setting modification, the network-device detecting unit 13c notifies the administrator of the presence of the uncontrollable device and the need for special settings, ending the process of detecting the network devices requiring setting modification.

For example, if the FW 20 is detected as a non-control network device when a new server for a new service is added, the process is continued to automatically modify the settings of the SLB 30 and the SW 40, then manually modifies the settings to allow communication with the IP address/port No. of the new service, because FW 20 does not communicate with the new server until the manual setting of the FW 20 is completed. If the SLB 30 is detected as a non-control network device, the network-device detecting unit 13c notifies the administrator that the setting modification of the SLB 30 is impossible. The reason for this is that if the process is continued to automatically modify the settings of the FW 20 before the manual setting modification of the SLB 30, there is a likelihood that the SLB will attempt to communicate with the new server 50 which is not included as a load distribution object.

The setting-modification-content determining unit 13d determines the setting modification content of the network device. Specifically, after the network-device detecting unit 13c ends the process of detecting the network devices requiring setting modification, the setting-modification-content determining unit 13d searches the service database 14b to check whether the server 50 is to be added for a new service or an existing service. If the server 50 is to be added for an existing service, the setting-modification-content determining unit 13d selects the modification content for each device. If the server 50 is to be added for a new service, the setting-modification-content determining unit 13d determines whether a sample is required for the setting modification of the network device requiring setting modification.

If no sample is required for setting modification, the setting-modification-content determining unit 13d selects the modification content for each device. If a sample is required for setting modification, the setting-modification-content determining unit 13d retrieves from the sample database 14 shown in FIG. 13, a plurality of samples corresponding to the network device requiring setting modification, outputs the samples to the output unit 16, and prompts the administrator to select a sample. After a sample or modification content is selected, the setting-modification-content determining unit 13d converts the modification content to a format acceptable by the network device.

The setting modifying unit 13e sets the selected setting modification content in the network device. Specifically, after the setting-modification-content determining unit 13d converts the modification content to a format acceptable by the network device, the setting modifying unit 13e sets the selected setting modification content in the network device. The setting modifying unit 13e then revises the network device database 14a and the service database 14b based on the setting modification of the network device.

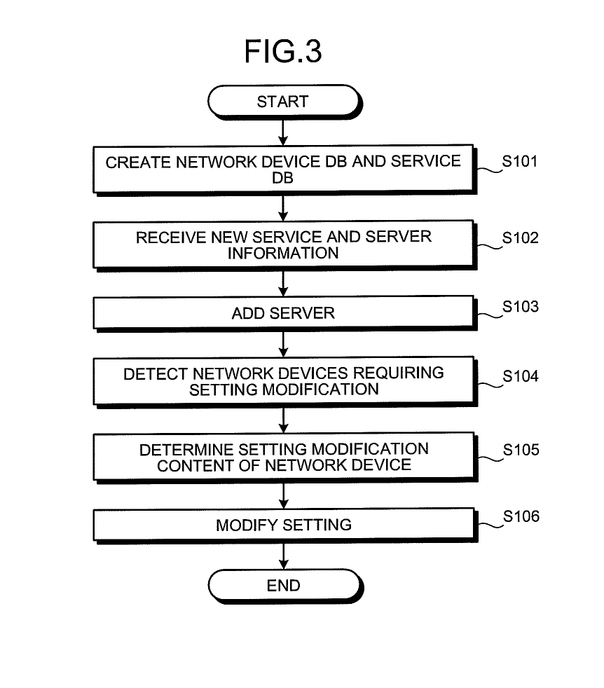

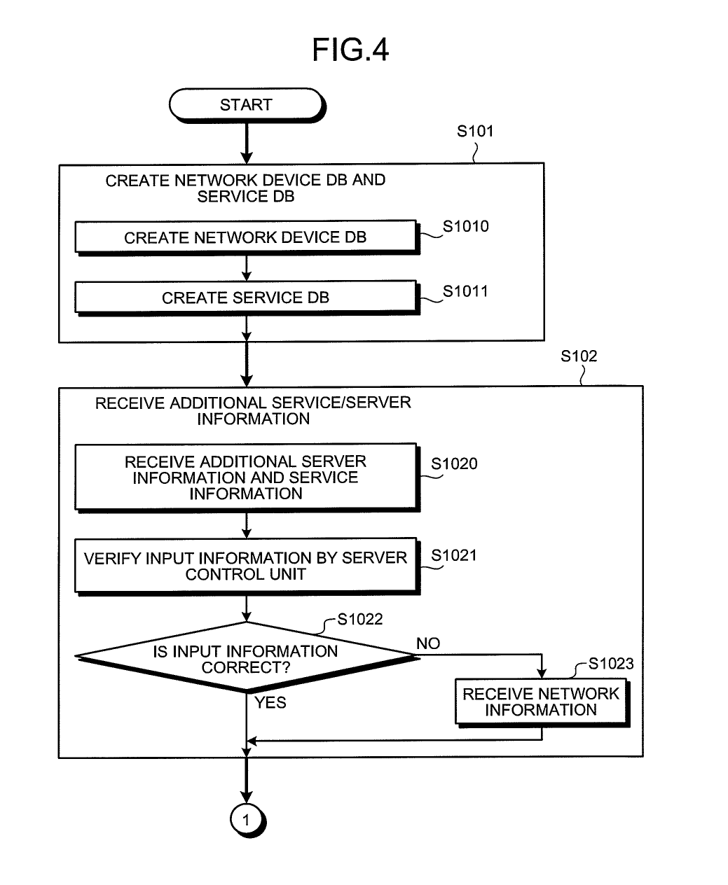

The processes performed by the network management device 10 according to the first embodiment are described below with reference to FIGS. 3 to 9. FIG. 3 is a general flowchart of all the processes performed by the network management device 10 according to the first embodiment. FIGS. 4 to 9 are detailed flowcharts of the processes performed by the network management device 10 according to the first embodiment.

A process of creation of the network device database 14a and the service database 14b (step S101) is described first with reference to FIG. 4. The database creating unit 13a of the network management device 10 stores the device information, the physical configuration, and the logical configuration of the network device, input via the input unit 15 in the network device database 14a, to build the network device database 14a (step S1010). The database creating unit 13a then verifies if the data stored in the network device database 14a is correct by executing an SNMP command. In addition, the database creating unit 13a also enters the service information and the server information input via the input unit 15 in the service database 14b to build the service database 14b (step S1011).

A process of receiving additional service and server information (step S102) is described next. The service-information receiving unit 13b receives the additional service information and server information input via the input unit 15 (step S1020), and verifies if the information is correct (that is, verifies whether an existing server is not being added) (step S1021). If the server information or the service information is not correct (that is, if a new service is added) (No at step S1022), the service-information receiving unit 13b requests input of network information concerning the network devices, and receives the information concerning the network via the input unit 15 (step S1023). The service-information receiving unit 13b then stores the service information, the server information, and the network information in the sample database 14c.

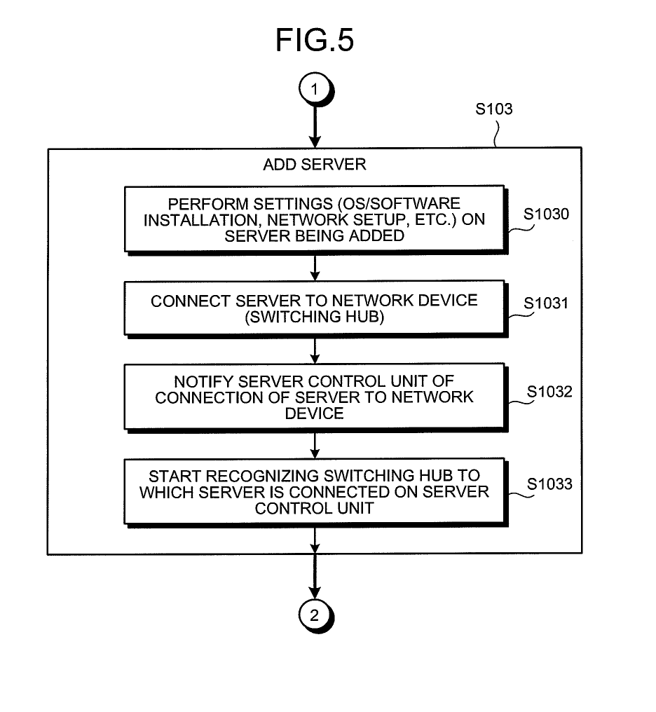

A process of adding a server (step S103) is described next with reference to FIG. 5. The network management device 10 performs various settings (for example, software installation, network setup, etc.) on the server 50 being added (step S1030), and connects the server 50 to the SW 40 (step S1031). The SW40 notifies the network-device detecting unit 13c that the server 50 is now connected to it (step S1032). Upon receiving the notification from the SW40, the network-device detecting unit 13c starts recognizing the SW40 connected to the server 50 (step S1033).

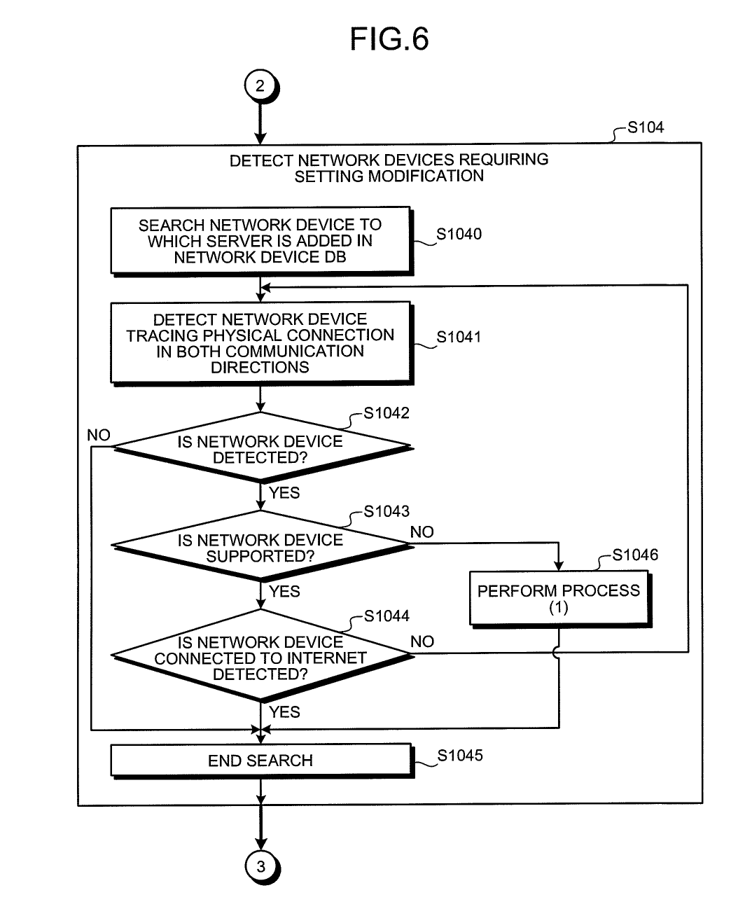

A process of detecting the network devices requiring setting modification (step S104) is described below with reference to FIG. 6. After recognizing the SW 40 connected to the server 50, the network-device detecting unit 13c, using the SW 40, looks in the network device database 14a for the network device to which the server 50 is added (step S1040). The network-device detecting unit 13c starts from the SW 40 and sequentially searches the devices in both directions (forward and backward) of communication (step S1041). If no network device is detected (No at step S1042), the network-device detecting unit 13c ends the search (step S1045).

If a network device is detected (Yes at step S1042), the network-device detecting unit 13c retrieves the device information concerning the network device from the network device database 14a, and determines whether the network device is controllable (step S1043). If the network device is controllable (Yes at step S1043), the network-device detecting unit 13c detects the next network device in the communication direction based on the physical connection relation, and traces the devices in the communication direction until a switch connected to the Internet or to another server group is detected (step S1044). If the SW 40 connected to the Internet or another server group is detected (Yes at step S1044), the network-device detecting unit 13c ends the process of detecting the network devices requiring setting modification (step S1045). If the detected network device is not controllable (No at step S1043), the network-device detecting unit 13c performs a process (1) described below (step S1046).

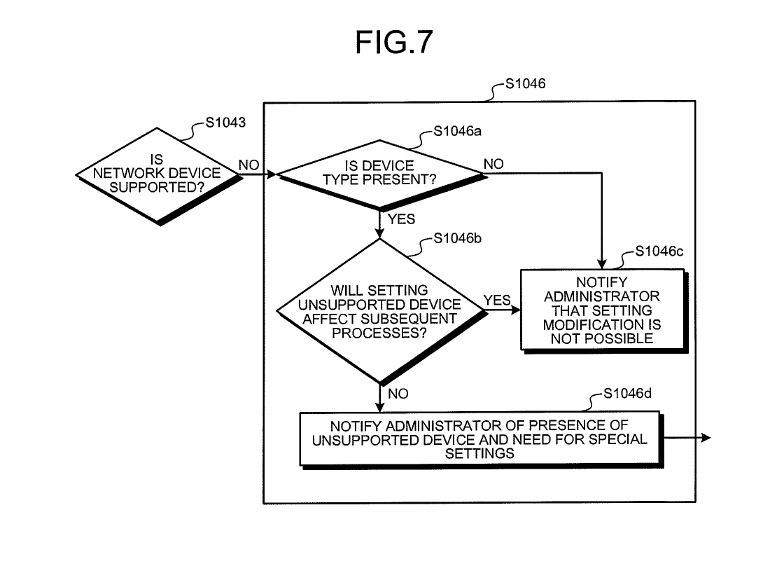

The process (1) is described next with reference to FIG. 7. If the detected network device is not controllable, the network-device detecting unit 13c searches whether the device type same as the detected network device is registered in the network device database 14a (step S1046a). If the device type same as the detected network device is not registered in the network device database 14a (No at step S1046a), the network-device detecting unit 13c outputs to the output unit 16 information indicating that the settings cannot be modified (step S1046c). If the device type same as the detected network device is registered in the network device database 14a (Yes at step S1046a), the network-device detecting unit 13c determines if setting modification of the network device will affect the subsequent processes (step S1046b). If the subsequent processes will be affected by setting modification (Yes at step S1046b), the network-device detecting unit 13c outputs to the output unit 16 information indicating that the settings cannot be modified (step S1046c). If the subsequent process will not be affected by setting modification (No at step S1046b), the network-device detecting unit 13c notifies the administrator of the presence of uncontrollable device (step S1046d) and the need for special settings, ending the process of detecting the network devices requiring setting modification (step S1045).

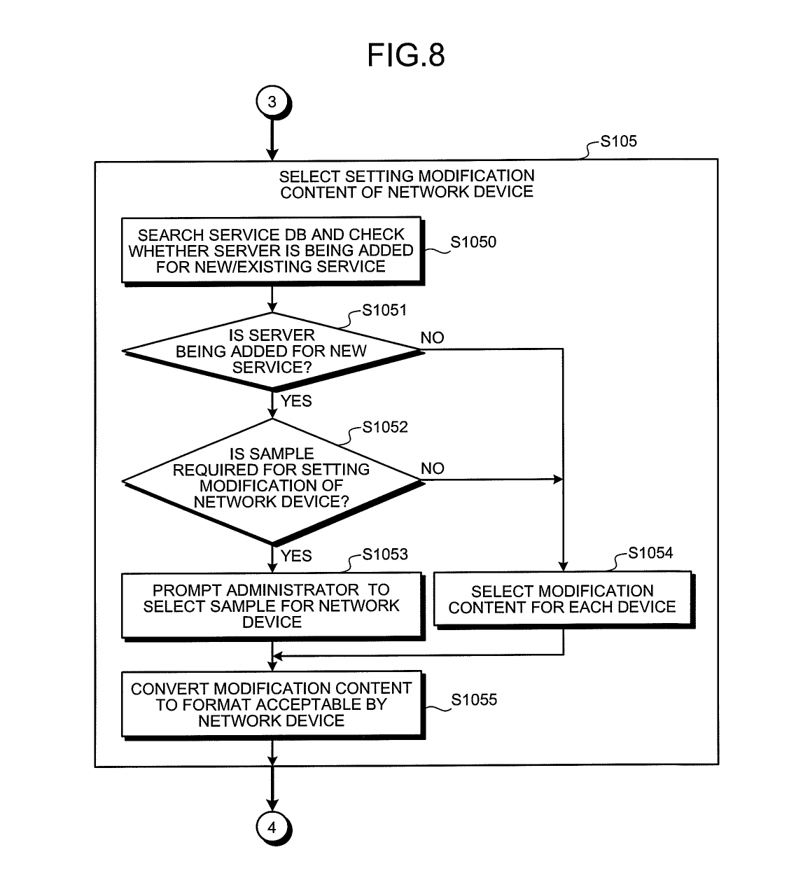

A process of selecting the setting modification content of the network device (step S105) is described next with reference to FIG. 8. After the process of detecting the network devices requiring setting modification ends (step S1045), the setting-modification-content determining unit 13d searches the service database 14b to check whether the server 50 is to be added for a new service or an existing service (step S1050). If the server 50 is to be added for an existing service (No at step S1051), the setting-modification-content determining unit 13d selects the modification content for each device (step S1054). If the server 50 is to be added for a new service (Yes at step S1051), the setting-modification-content determining unit 13d determines whether a sample is required for the setting modification of the network device requiring setting modification (step S1052). If no sample is required for setting modification (No at step S1052), the setting-modification-content determining unit 13d selects the modification content for each device (step S1054).

If a sample is required for setting modification (Yes at step S1052), the setting-modification-content determining unit 13d retrieves from the sample database 14 shown in FIG. 13, a plurality of samples corresponding to the network device requiring setting modification, outputs the samples to the output unit 16, and prompts the administrator to select a sample (step S1053). After a sample or modification content is selected (steps S1053 and S1054), the setting-modification-content determining unit 13d converts the modification content to a format acceptable by the network device (step S1055).

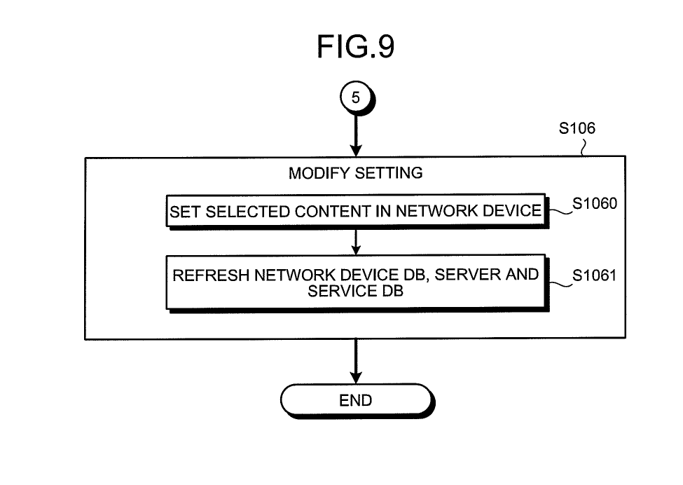

A process of implementing the setting modification (step S106) is described next with reference to FIG. 9. After the modification content is converted to a format acceptable by the network device, the setting modifying unit 13e sets the selected setting modification content in the network device (step S1060). The setting modifying unit 13e then revises the network device database 14a and the service database 14b (step S1061).

Thus, in the network management device 10, samples for setting structure definition of a network device are stored in the sample storage unit. When a server resource is added to the network for providing a new service, the network management device 10 detects network devices requiring structure definition modification, retrieves and presents to the administrator the structure definitions corresponding to the detected network device from the sample storage unit and presents, and modifies the structure definition of the network device based on the sample selected by the administrator. Consequently, setting modification of the network device is made based on the samples, thus reducing the workload involved in making the setting modification of the network devices and the proneness to human errors in the process.

According to the first embodiment, the network management device 10 stores in the sample storage unit a plurality of samples, and presents the samples to the administrator for selection. Upon selection of a sample by the administrator, the network management device 10 modifies the structure definition of the concerned network device based on the selected sample. Consequently, by enabling the administrator to select the appropriate sample, setting modification preferred by the administrator can be implemented and an extremely unsuitable setting modification can be prevented from being implemented.

According to the first embodiment, the samples in the sample storage unit are stored in an associated form with one or more of the network device type, location where the network device is connected in the network, and port No. to which the network device is connected, and the network management device 10 presents the samples from the sample storage unit according to one or more of the network device type, location of the network device in the network, and port No. to which the network device is connected. Consequently, setting modification that is appropriate for the network device can be made.

According to the first embodiment, the network management device 10 detects the network devices requiring modification of structure definition starting from the switch to which the server for the new service is connected, tracing all the network devices until another network, another switch or a non-control network device is encountered. Consequently, search for the network devices requiring setting modification can be carried out properly.

According to the first embodiment, when a non-control network device is detected, based on the type of the detected network device, the network management device 10 determines whether detection of network device can be allowed to continue until another network or another switch is detected. If detection of network device is allowed to continue, the network management device 10 continues the detection process until another network or another switch is detected. For example, if a firewall is detected as a non-control network device, the network management device 10 continues the detection process since the firewall will not be able to communicate with the new server until the setting of the firewall is manually modified. However, if a server load balancer is detected as a non-control network device, the detection process is halted for allowing manual modification of the setting of the server load balancer as there is a likelihood that the server load balancer will attempt to communicate with the new server before it is included in the load distribution object. Thus, searching of the network device requiring setting modification can be appropriately made.

According to the first embodiment, the network management device 10 notifies the administrator when a non-control network device is detected. Consequently, the setting of the non-control network device can be manually modified thereafter.

In the first embodiment, the network management device 10 presents to the administrator a plurality of samples, prompting the administrator to select a sample from among the presented samples. The network management device 10 can also be configured to present to the administrator samples having designated data already input in a modifiable manner, prompting the administrator to modify the designated parameters.

Thus, the network management device 10 detects the network devices requiring modification of structure definition starting from the switch to which the server for the new service is connected, tracing all the network devices until another network, another switch or a non-control network device is detected. Consequently, the network management device 10 appropriately detects the network device requiring setting modification.

In the first embodiment, the administrator is prompted to make setting modification on the network device based on the samples. However, the network management device 10 can be configured to automatically make setting modification based on the samples.

The constituent elements of the device are merely conceptual and may not necessarily physically resemble the structures shown in the drawings. For instance, the device need not necessarily have the structure that is illustrated in the drawings. The device as a whole or in parts can be broken down or integrated either functionally or physically in accordance with the load or how the device is to be used. For example, the database creating unit 13a and the service-information receiving unit 13b can be integrated as a single unit. The process functions performed by the device can be entirely or partially realized by a central processing unit (CPU) or a computer program analyzed and executed by the CPU or by a hardware using wired logic.

All the automatic processes explained in the present embodiment can be, entirely or in part, carried out manually by a known method. Similarly, all the manual processes explained in the present embodiment can be, entirely or in part, carried out automatically by a known method. The process procedures, the control procedures, specific names, and data, including various parameters, mentioned in the description and drawings can be changed as required unless otherwise specified.

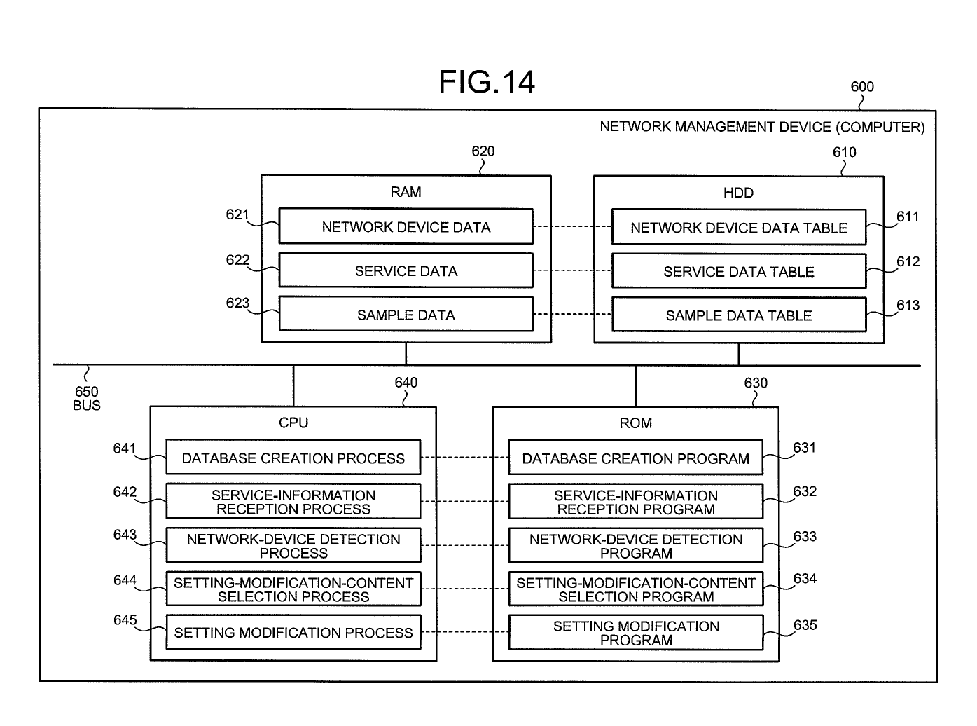

The various processes described in the first embodiment can be implemented using a network management program readable by a computer. FIG. 14 is a block diagram of a computer 600 that can implement the network management program.

The computer 600 includes a hard disk drive (HDD) 610, a random access memory (RAM) 620, a read-only memory (ROM) 630, and a CPU 640, all of which are interconnected by a bus 650.

The ROM 630 already has stored therein various programs for implementing the functions of the network management device 10 according to the first embodiment, namely, a database creation program 631, a service-information reception program 632, a network-device detection program 633, a setting-modification-content selection program 634, and a setting modification program 635. Like the constituent elements of the network management device 10 shown in FIG. 2, the programs 631 to 635 can be integrated or broken down as the situation demands.

The CPU 640 reads the programs 631 to 635 to implement, respectively, a database creation process 641, a service-information reception process 642, a network-device detection process 643, a setting-modification-content selection process 644, and a setting modification process 645. The processes 641 to 645 correspond, respectively, to the database creating unit 13a, the service-information receiving unit 13b, the network-device detecting unit 13c, the setting-modification-content determining unit 13d, and the setting modifying unit 13e shown in FIG. 2.

The HDD 610 includes a network device data table 611, a service data table 612, and a sample data table 613, which correspond to the network device database 14a, the service database 14b, and the sample database 14c of FIG. 2, respectively. In addition to storing data in the network device data table 611, the service data table 612, and the sample data table 613 as network device data 621, service data 622, and sample data 623, respectively, the CPU 640 reads the network device data 621, the service data 622, and the sample data 623 into the RAM 620 to perform data processing.

According to an embodiment of the present invention, setting modification of network devices can be made based on samples, thus reducing the workload involved in making setting modification of the network devices and the proneness to human errors in the process.

According to the embodiment, by enabling an administrator to select the appropriate sample from among a plurality of samples, setting modification preferred by the administrator can be implemented and unsuitable setting modification can be prevented from being implemented.

According to the embodiment, an administrator can make minute setting modifications to suit the requirement.

According to the embodiment, setting modification that is appropriate for the network device can be made.

According to the embodiment, search for the network devices requiring setting modification can be carried out properly.

According to the embodiment, if a firewall is detected as a non-control network device, the network management device 10 continues the detection process since the firewall will not be able to communicate with the new server until the setting of the firewall is manually modified. However, if a server load balancer is detected as a non-control network device, the detection process is paused for allowing manual modification of the setting of the server load balancer as there is a likelihood that the server load balancer will attempt to communicate with the new server before it is included in the load distribution object. Thus, searching of the network device requiring setting modification can be appropriately made.

According to the embodiment, the setting of the non-control network device can be later manually modified.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer program product having a computer readable medium including programmed instructions for managing structure definition of network devices that form a network, wherein the instructions, when executed by a computer, cause the computer to perform:
registering, in a sample storage unit, a sample for setting configuration definitions of the network devices;
searching for a network device requiring modification of structure definition when a server resource is added to provide a new service;
reading, from the sample storage unit, the sample corresponding to the network device detected by the searching to present the sample; and
modifying the configuration definition of the network device based on information received from the sample presented.

2. The computer program product according to claim 1, wherein
the registering includes registering a plurality of samples in the sample storage unit so that the samples are selectable by a user,
the reading includes reading, from the sample storage unit, a plurality of samples for setting the configuration definitions to present the samples to the user, and
the modifying includes modifying the configuration definition based on the information received from one selected from among the samples presented.

3. The computer program product according to claim 1, wherein
the registering includes registering, in the sample storage unit, the sample in which designated data is already input in a modifiable manner, and
the reading includes reading the sample having the designated data already input in a modifiable manner to present the sample.

4. The computer program product according to claim 1, wherein
the registering includes registering the sample in the sample storage unit so that the sample is associated with one or more of a type of the network device, a connection location of the network device, and a port number where the network device is connected, and
the reading includes reading, from the sample storage unit, the sample based on one or more of the type of the network device, the connection location of the network device, and the port number where the network device is connected to present the sample.

5. The computer program product according to claim 1, wherein
the searching includes searching for the network device requiring structure definition modification so that the searching starts from a switch where the server added for offering the new service is connected and ends when another network, switch, or non-control network device is detected.

6. The computer program product according to claim 1, wherein the searching includes
when a non-control network device is detected, determining whether the searching is allowed to be continued until another network or switch is detected, and if further searching is allowed, continuing the searching until another network or switch is detected.

7. The computer program product according to claim 1, wherein the modifying includes when a non-control network device is detected, notifying an administrator of the detection.

8. A network management device for managing structure definition of network devices that form a network, the network management device comprising:
a sample registering unit that registers in a sample storage unit a sample for setting configuration definitions of the network devices;
a network-device searching unit that searches for a network device requiring modification of structure definition when a server resource is added to provide a new service;
a sample presenting unit that reads, from the sample storage unit, the sample corresponding to the network device detected by the network-device searching unit to present the sample; and
a structure-definition modifying unit that modifies the configuration definition of the network device based on information received from the sample presented by the sample presenting unit.

9. A network management method for managing structure definition of network devices that form a network, the network management method comprising:
registering, in a sample storage unit, a sample for setting configuration definitions of the network devices;
searching for a network device requiring modification of structure definition when a server resource is added to provide a new service;
reading, from the sample storage unit, the sample corresponding to the network device detected by the searching to present the sample; and
modifying the configuration definition of the network device based on information received from the sample presented.
